(19) United States
(12) Patent Application Publication
(10) Pub. No.: US 2026/0193496 A1
(43) Pub. Date: Jul. 9, 2026

(54) PRESSURE-SENSITIVE ADHESIVE COMPOSITIONS AND ARTICLES INCLUDING THE SAME

(71) Applicant: 3M INNOVATIVE PROPERTIES COMPANY, St. Paul (MN)

(72) Inventors: Grant Fahnhorst, Minneapolis, MN (US); Adam R. Wohl, Mahtomedi, MN (US)

(21) Appl. No.: 19/132,463

(22) PCT Filed: Nov. 20, 2023
(86) PCT No.: PCT/IB2023/061698

§ 371 Date: May 23, 2025

Related U.S. Application Data
(60) Provisional application No. 63/432,605, filed on Dec. 14, 2022.

(51) Int. Cl. C09J 133/08

(52) U.S. Cl. CPC C09J 133/08

(57) ABSTRACT

Pressure-sensitive adhesive compositions including a copolymer comprising a first divalent monomer unit represented by the structure (I) wherein Y is a heterohydrocarbyl group having up to having up to 18 carbons; and R¹ is —H or —CH₃; and a second divalent monomer unit represented by the structure (II) wherein X is a hydrocarbylene group having up to 5 carbons; R¹ is —H or —CH₃; and each R² and R³ is independently —H or a hydrocarbyl group having up to 8 carbons. Articles including the disclosed pressure-sensitive adhesive compositions and methods of preparing the disclosed pressure-sensitive adhesive compositions are provided.

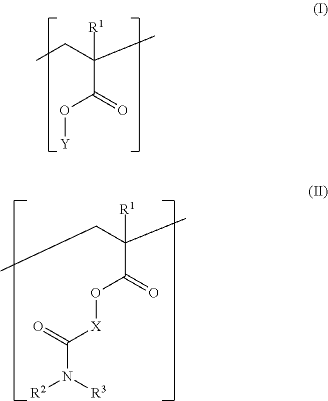

### TECHNICAL FIELD

The present disclosure relates generally to the field of adhesives, more specifically to the field of pressure sensitive adhesives.

### BACKGROUND

Adhesives are used in a variety of marking, holding, protecting, sealing, and masking applications. Adhesive tapes generally comprise a backing, also referred to as a substrate, and an adhesive. One type of adhesive which is particularly preferred for many applications is represented by pressure sensitive adhesives. Pressure sensitive adhesives (“PSAs”) are known to possess certain properties including the following: (1) aggressive and permanent tack, (2) adherence with no more than finger pressure, (3) sufficient ability to hold onto an adhered, and (4) sufficient cohesive strength.

### SUMMARY

In one aspect, the present disclosure provides pressure-sensitive adhesive compositions including a copolymer comprising a first divalent monomer unit represented by the structure

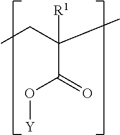

wherein Y is a heterohydrocarbyl group having up to having up to 18 carbons; and R¹ is —H or —CH₃; and a second divalent monomer unit represented by the structure

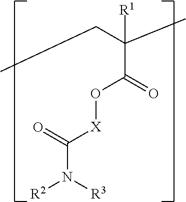

wherein X is a hydrocarbylene group having up to 5 carbons; R¹ is —H or —CH₃; and each R² and R³ is independently —H or a hydrocarbyl group having up to 8 carbons.

In another aspect, provided herein are articles including pressure-sensitive adhesive compositions of the present disclosure.

In another aspect, provided herein are methods of preparing pressure-sensitive adhesive compositions of the present disclosure.

Features and advantages of the present disclosure will be further understood upon consideration of the detailed description as well as the appended claims.

### DETAILED DESCRIPTION

Acrylamide is employed in the formulations of many applications, including pressure-sensitive adhesives (“PSAs”). The high polarity and hydrogen bonding properties of acrylamide can produce PSAs with good cohesive strength, even at low loadings. The primary amide achieves this reinforcement through hydrogen bonding without degrading sensitive materials (e.g. electronics) and with minimal adhesion build over time. However, there are growing concerns over the use of acrylamide since it is a known sensitizer and acute toxin which can absorb through skin. Additionally, acrylamide is a solid, which can create difficulties in safe handling. Further, the limited solubility of acrylamide in common monomers may preclude its use in hot-melt adhesive platforms. Accordingly, N-vinylpyrrolidone (“NVP”) and N,N-dimethylacrylamide (“DM-Acm”) are commonly used as substitutes for acrylamide. However, NVP and DM-Acm do not hydrogen bond as effectively as acrylamide because each is a substituted, rather than a primary, amide. Hence, adhesive formulations including NVP and DM-Acm may require much higher loadings of NVP and DM-Acm compared to acrylamide to achieve similar performance. It has been surprisingly discovered that the use of lactamide acrylate (“L-Acm”) in adhesive formulations can overcome many of the deficiencies of using acrylamide, NVP, and DM-Acm in such compositions.

Desirably, lactamide acrylate (“L-Acm”) monomer contains the primary amide functionality vital for PSA performance but is more hydrophobic than acrylamide. L-Acm is a liquid at ambient temperatures and has increased solubility in common acrylate monomers while simultaneously improving the cohesive strength of adhesive formulations to which it is added. Furthermore, the L-Acm monomer may be derived from renewable precursors and may exhibit reduced toxicity as compared to acrylamide, thus making L-Acm both a sustainable and environmentally friendly alternative.

L-Acm may be prepared according to methods know to those of ordinary skill in the relevant arts such as, for example, by reacting acryloyl chloride and lactamide in the presence of dimethyl formamide and dichloromethane solvents, followed by treatment of the resulting products with a potassium carbonate/acetone solution. L-Acm so prepared may then be used to prepare copolymer preparations useful as pressure-sensitive adhesive compositions, using methods know to those of ordinary skill in the relevant arts and as outlined below. In some aspects, the pressure-sensitive adhesive compositions according to the present disclosure are crosslinked by methods known to those of ordinary skill in the relevant arts such as, for example, with actinic radiation or with e-beam irradiation.

Provided herein are pressure-sensitive adhesive compositions including a copolymer including a first divalent monomer unit represented by the structure

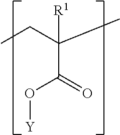

wherein Y is a heterohydrocarbyl group having up to having up to 18 carbons and R¹ is —H or —CH₃, and a second divalent monomer unit represented by the structure

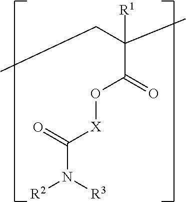

wherein X is a hydrocarbylene group having up to 5 carbons, R¹ is —H or —CH₃, and each R² and R³ is independently —H or a hydrocarbyl group having up to 8 carbons. In some embodiments X may represent an aliphatic hydrocarbylene group. In some preferred embodiments, X may selected from the group consisting of —CH(CH₃)—, —CH(CH₃)CH₂CH₂—, —CH₂CH₂CH(CH₃)—, and combinations thereof.

The pressure-sensitive adhesive composition of some embodiments of the present disclosure commonly include copolymer comprising 99.5 wt. % to 75 wt. %, optionally 97 wt. % to 86 wt. % of the first divalent monomer unit and 0.5 wt. % to 25 wt. %, optionally 3 wt. % to 14 wt. % of the second divalent monomer unit. In some preferred embodiments the first divalent monomer unit is selected from the group consisting of an isooctylacrylate divalent monomer unit, a 2-ethylhexylacrylate divalent monomer unit, a butylacrylate divalent monomer unit, and combinations thereof. Pressure-sensitive adhesive compositions of the present disclosure will commonly includer a copolymer having an inherent viscosity of 0.35 to 2, optionally 0.75 to 1 as determined by the Inherent Viscosity Test described in the Examples below.

In some embodiments, the pressure-sensitive adhesive compositions of the present disclosure may include a copolymer that is free of monomer units selected from the group consisting of acrylamide monomer units, N,N-dimethylacrylamide monomer units, and combinations thereof. As used herein, the term “free of” refers to a copolymer including less than 5 wt. %, less than 2 wt. %, less than 1 wt. %., less than 0.5 wt. %, less than 0.1 less than 0.01 wt. %, or 0 wt. % of a particular monomer unit.

In some embodiments, the pressure-sensitive adhesive compositions may further include a polar monomer. Representative examples of suitable polar monomers include but are not limited to (meth)acrylic acid, 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; tetrahydrofurfuryl (meth)acrylate, poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of (meth)acrylic acid, N-vinylpyrrolidone, and combinations thereof. The polar monomer may be present in amounts of 0 to 10 parts by weight, preferably 0.5 to 5 parts by weight, based on 100 parts by weight total monomer.

An initiator for free radical polymerization is typically added to the various monomers used to form a polymerizable material, i.e., the monomer/initiator mixture. The polymerization initiator can be a thermal initiator, a photoinitiator, or both. Any suitable thermal initiator or photoinitiator known for free radical polymerization reactions can be used. Suitable initiators include but are not limited to those selected from the group consisting of azo compounds such as, for example, VAZO 64 (2,2′-azobis(isobutyronitrile)) and VAZO 52 (2,2′-azobis(2,4-dimethylpentanenitrile)), both available from E.I. du Pont de Nemours Co., Wilmington, DE, USA; peroxides such as benzoyl peroxide and lauroyl peroxide, and mixtures thereof. In some preferred embodiments, the initiator comprises benzoyl peroxide. The initiator is typically present in an amount in the range of 20 to 10,000 ppm and commonly 20 to 2,000 ppm based on a total weight of polymerizable material. In some embodiments, an optional chain transfer agent (e.g., isopropanol, benzene, toluene, chloroform, 1-butanethiol) or optional solvent (e.g., methanol, tetrahydrofuran, ethanol, isopropanol, acetone, methyl ethyl ketone, methyl acetate, ethyl acetate, toluene, xylene, an ethylene glycol alkyl ether) and mixtures thereof may also be added to the monomer/initiator mixture used to form the polymerizable material.

The pressure-sensitive adhesive compositions may also include other additives. Examples of suitable additives include, but are not limited to, tackifiers (e.g., rosin esters, terpenes, phenols, and aliphatic, aromatic, or mixtures of aliphatic and aromatic synthetic hydrocarbon resins), surfactants, plasticizers (other than physical blowing agents, e.g. polyisobutylenes, mineral oils, ethylene propylene diene monomer rubbers, various polyalkylene oxides (e.g., polyethylene oxides or propylene oxides), adipic acid esters, formic acid esters, phosphoric acid esters, benzoic acid esters, phthalic acid esters, sulfonamides, naphthenic oils), nucleating agents (e.g., talc, silica, or TiO₂), pigments, dyes, reinforcing agents, solid fillers, stabilizers (e.g., UV stabilizers), and combinations thereof. In some preferred embodiments the additive is selected from the group consisting of a tackifier, a plasticizer, and combinations thereof. The additives may be added in amounts sufficient to obtain the desired properties for the cured composition being produced. The desired properties are largely dictated by the intended application of the resultant polymeric article. In some preferred embodiments the pressure-sensitive adhesive composition comprises from 3 parts to 60 parts by weight of the additive for every 100 parts by weight of the copolymer.

The pressure sensitive adhesive compositions of the present disclosure may be used in articles conventionally known to use such materials such as, for example, labels, tapes, signs, covers, marking indices, display components, touch panels, and the like. The pressure sensitive adhesive compositions of the present disclosure may also be particularly useful in a variety of medical applications, such as, for example, in dressings, electrodes, medical devices worn by a patient (e.g., sensors (generically) or continuous glucose monitoring devices (specifically)), as well as other wearable electronics.

The pressure-sensitive adhesive compositions may be coated/applied (i.e., disposed) on a substrate using any conventional coating techniques modified as appropriate to the particular substrate. For example, pressure sensitive adhesive compositions may be applied/coated to a variety of solid substrates by methods such as roller coating, flow coating, dip coating, spin coating, spray coating knife coating, and die coating. These various methods of coating allow the resulting pressure-sensitive adhesive assemblies to be placed on the substrate at variable thicknesses thus allowing a wider range of use of the assemblies. In some preferred embodiments, the substrate comprises stainless steel and the pressure-sensitive adhesive compositions has a peel strength of at least 3 Newtons as determined by the Peel Adhesion Force Test described in the Examples below.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all pants, percentages, ratios, etc. in the Examples and the rest of the specification are by weight. The following abbreviations are used inthe Examples section: phr=parts per hundred rubber, g=grams, mg=milligrams, kg=kilograms, GPC=gel permeation chromatography, mL=milliliters, oL=microliters, ppm=parts per million, mm=millimeters, cm=centimeters, ° C.=degrees Celsius, PTFE=polytetrafluoroethylene, Hz=Hertz, N=Newtons, in=inches, oz=ounces, h=hour(s).

Materials Used in the Examples

| Abbreviation | Description |
|---|---|
| IOA | Isooctyl acrylate, a monomer available from 3M Company, |
| | St. Paul, MN, USA |
| Acm | Acrylamide, a monomer available from Mytech Specialty |
| | Chemicals, Gaffney, SC, USA |
| IPA | Isopropanol, ACS Grade available from VWR Chemical, |
| | Radnor, PA, USA |
| BPO/ A75 | Benzoyl peroxide, from Sigma Aldrich, Burlington, MA, |
| | USA |
| EtOAc | Ethyl Acetate, HPLC Grade available from Sigma Aldrich, |
| | Burlington, MA, USA |
| L-Acm | Lactamide acrylate, prepared as described under PE-1, |
| | below |
| AEBP | 4-acryloyloxyethoxy benzophenone, a polymerizable |
| | photocrosslinker available from 3M Company, St. Paul, |
| | MN, USA |
| Liner | 3M TEGADERM liner, available from 3M Company, St. |
| | Paul, MN, USA |
| | Primed PET, available from Mitsubishi Polyester Film |
| | LLC, Greer, SC, USA |
| | Acryloyl chloride, available from Sigma Aldrich, |
| | Burlington, MA, USA |
| | Lactamide, available from TCI America, Portland OR, USA |
| K₂CO₃ | Potassium carbonate, (99.0% min), available from Alfa |
| | Aesar, Haverhill, MA, USA |
| MeOH | Methanol, ACS Grade available from VWR Chemical, |
| | Radnor, PA, USA |

### Test Methods

### Test Method 1: GPC Analysis

Approximately 30 mg of polymeric solids were placed in 10 mL of tetrahydrofuran (stabilized with250 ppm BHT). Samples were mixed on a mechanical shaker (obtained under the trade designation E6010.00 from Eberbach Corporation, Belleville, MI) at low speed for approximately two hours. The resulting solution was filtered through a 0.45-micron syringe filter and analyzed by GPC. The GPC consisted of a pump, columns and a detector. The pump was obtained under the trade designation “AGILENT 1100 HPLC” from Agilent Technologies, Santa Clara, CA. The columns used were as follows: Two of nominal MW range 500-107 Daltons (obtained under the trade designation “PLGEL 10 MICRON MIXED-B” from Agilent Technologies, Santa Clara, CA) and one of nominal MW range 200-400,000 Daltons, (obtained under the trade designation “PLGEL 5 MICRON MIXED-D” from Agilent Technologies). All columns were 7.8 mm×300 mm columns held at 40° C. The detector was a Refractive Index Detector obtained under the trade designation “1200 SERIES G1362” from Agilent Technologies, Santa Clara, CA. The mobile phase was Tetrahydrofuran-UV Grade, stabilized (obtained under the trade designation “EMD OMNISOLV” from MilliporeSigma Co., Burlington, MA); or equivalent grade with a flow rate of 1.0 mL/min. Standards were narrow dispersity linear polystyrene, 6.57E+6 to 580 g/mol; (third order polynomial fit) obtained under the trade designation “EASICAL PS-1” from Agilent, Santa Clara, CA. Calculations were performed using Agilent Open Lab software. The samples were prepared and analyzed in duplicate, and the average of the two values was reported. The following definitions are used in reporting GPC results: Mw=Weight-average molecular weight, Mn=Number-average molecular weight, Polydispersity=Mw/Mn, a figure related to the width of the distribution curve.

### Test Method 2: Determination of T_{g}

Copolymer samples were analyzed using a rheometer available under the trade designation ARES G2 from TA Instruments, Columbus, OH, using an 8 mm parallel plate top, 25 mm bottom plate, a forced convection oven and liquid nitrogen for sub-ambient temperatures, operated with the following parameters:
Oscillation at 0.1% strain, 1 Hz
5±2 N Compression normal force (0.5 stiffness compensation)
Temp ramp from −85 to 150° C. at 3° C./min.

Copolymer samples coated from solution onto a liner, dried at 65 \hat{ }C for 15 minutes, and covered with a second liner and stored until rheological analysis was performed. For the analysis, both liners were removed and adhesive repeatedly folded upon itself to provide a cylindrical shape suitable for the measurement. The cylindrical samples were loaded on the 150° C. bottom plate and rolled to remove bubbles. The top plate was lowered to ~1 mm and sample exceeding the diameter of the top plate was trimmed. Temp manually lowered −85° C.

### Test Method 3: Inherent Viscosity (“IV”) Test

The flow time of a 10-mL solution (0.15 g per 100 mL polymer in ethyl acetate) was analyzed using a Lauda Viscometer (27° C. water bath temp). The test procedure followed, and the apparatus used, were described in detail in Textbook of Polymer Science, F. W. Billmeyer, Wiley-Interscience, Second Edition, 1971, Pages 84 and 85.

### Test Method 4: Peel Adhesion Force Test

Peel adhesion force was measured using adhesive tapes prepared by coating copolymer solutions onto primed PET. These samples were then dried in a oven at 65° C. for 20 minutes, and aged at ambient temperature for 24 h prior to testing. Samples for peel testing were cut to 1.27 cm widths and allowed to dwell for 30 minutes prior to testing. A stainless-steel panel was cleaned by wiping with acetone and heptane and drying. Adhesive tapes measuring 12.7 mm wide by 10 to 12 cm long were adhered to the panel by rolling with a 2 kg hard rubber roller 2 times. The free end of the adhesive tape was doubled back so that the angle of removal was 1800 and attached to the horizontal arm of an adhesion tester scale (SLIP/PEEL TESTER MODEL 3M90, obtained from Instrumentors Inc. Strongsville, OH, USA). The stainless-steel plate was attached to the platform that moved at 12 inches per minute (30.5 centimeters per minute) away from the scale. The peel test was started after a 30-minute dwell time. The scale was read in ounces during the test as an average of the stabilized peel force. Three peel tests were run for each sample and averaged to yield the reported peel force presented in Table 3. 2-bond failure was reported when the adhesive was removed from the film (e.g., primed PET) and little to no residue onto the substrate (e.g., stainless steel). Adhesive failure was reported when the adhesive left no residue onto the substrate (e.g., stainless steel). Cohesive failure was reported when adhesive residue was observed on both the substrate (e.g., stainless steel) and film (e.g., primed PET film)

Ghosting was reported when adhesive failure was the main failure mechanism and a small amount of residue was observed along the edges of the film.

### Test Method 5: Adhesive Shear Strength Test

Shear tests were conducted using 25.4 millimeter (mm) wide samples of adhesive tape prepared by coating copolymer onto primed PET with a coating thickness of 0.0254 mm (1 mil). Samples for shear testing were allowed to dwell for 10 minutes prior to testing and were tested at 23° C. A stainless-steel panel was cleaned by wiping with acetone and heptane and air drying. The samples of adhesive tape were applied to the panel such that a 25.4 mm by 25.4 mm portion of each adhesive tape was in firm contact with the panel and one end portion of each adhesive tape free (i.e., not attached to the panel). A 1000 gram weight was attached to the free end of the adhesive tape sample and the panel was held in a rack so that the panel formed an angle of 180° with the extended free end and the weight. The test was conducted at room temperature and 70° C. and the time elapsed in minutes for each adhesive tape to separate from the test panel was recorded as shear strength. If the time elapsed exceeded 10,000 minutes, the time elapsed was recorded as >10,000 minutes. Three shear tests were performed for each adhesive tape sample and the results averaged and presented in Table 3. Failure mechanisms were reported using the same definitions as those described in Peel Adhesion Force Test above.

### EXAMPLES

### Preparative Example 1 (PE-1) Lactamide acrylate

Lactamide (64.7 g, 726 mmol) and dimethyl formamide (75 g) were added to a 2-L, three neck round-bottom flask fitted with a stir bar. The contents were stirred to form a homogenous solution. Acryloyl chloride (78.9 g, 872 mmol) was diluted with dichloromethane (265 g), and solution added over four minutes to the 2-L flask. After 5 h, a saturated, aqueous solution of sodium bicarbonate was added, and the solution was allowed to mix overnight. The biphasic mixture was separated, and the organic phase was washed (aqueous NaHCO₃ followed by brine). The combined aqueous layers were extracted once with ethyl acetate, the combined organic layers were dried (MgSO₄), and concentrated under vacuum to give a yellow oil.

A portion of this yellow oil (101 g), acetone (600 g), potassium carbonate (29.3 g, 212 mmol) and a stir bar were added to a 2-L round bottom flask, and slurry was stirred for 72 h. The solution was concentrated under vacuum, ethyl acetate was added to the flask (400 g), and the suspension was filtered (celite). The solution was then concentrated under vacuum, and a steady stream of air was bubbled through the solution over 48 hours to further remove DMF to afford lactamide acrylate (28.0 g, 195 mmol, 27% yield over two steps).

Copolymer preparation: For each Example EX-1 through EX-4 and Comparative Example CE-1 through CE-3, monomers (12.0 g total), AEBP (0.05 phr, 0.120 g, added as a 5% solution), and BPO/A75 initiator (0.15 phr, or 18 mg) were added to a 4-oz amber glass bottle with the relative masses as shown in Table 1. Isopropyl alcohol and ethyl acetate (EtOAc) were added so that the total monomer concentration targeted 50% by mass (total monomer+solvent solution=24 g). The bottle was capped using a teflon-lined cap and the contents of the bottle were thoroughly mixed, the cap was removed, and solution was degassed by bubbling a constant stream of nitrogen gas (1 L/min) through the solution for thirty seconds. The bottle was again sealed using a Teflon-lined cap and placed in a LAUNDER-OMETER Model M228AA, available from Atlas Electric Devices Co., Chicago, IL containing a water bath at 60° C. for 20 hours. After 20 hours, the bottle was removed, the solution was diluted with an additional charge of EtOAc (12 g) so that the final polymer concentration was approximately 33% polymer by mass (33% by mass polymer, 67% by mass solvent).

The IV of the polymer was measured according to the procedure Determination of IV (results presented in Table 2). For CE-3, EX-3, and EX-4, samples were also measured according to the GPC Analysis procedure. Mₙ and polydispersity for these samples are presented in Table 2. CE-3, EX-3, and EX-4, were coated directly from solution onto a release liner, the liner and polymer were dried in an oven (65° C., 15 minutes), and a second liner was added to the top surface. T_{g} of these samples was measured according to the Determination of T_{g} procedure. Samples of CE-3, EX-3, and EX-4, were measured by the Determination of Peel Adhesion Force procedure and Determination of Adhesive Shear Strength procedure with and without crosslinking using a calibrated amount of UVC light from a calibrated H bulb fitted onto a Fusion UV system, Inc. conveyor belt (Model DRS-110QN). Peel adhesion and adhesive shear strength results are presented in Table 3.

TABLE 1
Copolymer Formulations

| | | | | AEBP | | | |
|---|---|---|---|---|---|---|---|
| | | | | (phr, | | | |
| Example | | | | added as | | | |
| (“EX”) or | | | | a 5% | Monomer | | |
| Comparative | Monomers | | | solution | concentration | Isopropyl | |
| Example | IOA | Acm | L-Acm | in | (%) (diluted | alcohol | BPO/A75 |
| (“CE”) | (wt %) | (wt %) | (wt %) | EtOAc) | with EtOAc) | (phr) | (phr) |
| CE-1 | 99 | 1 | — | 0.05 | 50 | 3 | 0.15 |
| CE-2 | 98 | 2 | — | 0.05 | 50 | 3 | 0.15 |
| CE-3 | 97 | 3 | — | 0.05 | 50 | 3 | 0.15 |
| EX-1 | 99 | — | 1 | 0.05 | 50 | 3 | 0.15 |
| EX-2 | 98 | — | 2 | 0.05 | 50 | 3 | 0.15 |
| EX-3 | 97 | — | 3 | 0.05 | 50 | 3 | 0.15 |
| EX-4 | 94 | — | 6 | 0.05 | 50 | 3 | 0.15 |

TABLE 2
Characterization

| Example or | | Mn | |
|---|---|---|---|
| Comparative | | (kg · mol⁻¹), | T_{g} |
| Example | IV | Polydispersity | (° C.) |
| CE-1 | 0.83 | — | — |
| CE-2 | 0.84 | — | — |
| CE-3 | 0.85 | 120, 5.0 | −33.1 |
| EX-1 | 0.85 | — | — |
| EX-2 | 0.87 | — | — |
| EX-3 | 0.88 | 120, 6.0 | −34.1 |
| EX-4 | 0.94 | 119, 7.0 | −25.2 |

TABLE 3
Characterization

| | | Peel | | | |
|---|---|---|---|---|---|
| | | Strength | | Shear | |
| | | [stainless | | (min., | |
| Example or | Crosslinked | steel, | | 500 g, | |
| Comparative | (28 mJ | oz · in²] | | 0.25 in² = | Shear |
| Example | UVC) | (Newtons) | Peel failure | 1.61 cm²) | failure |
| CE-3 | No | 24.6 ± 1.5 | adhesive | 5 + 0 | cohesive |
| | | (6.8 + 0.4) | (clean) | | |
| EX-3 | No | 41.7 + 2.1 | 2 bond | — | — |
| | | (11.6 ± 0.6) | | | |
| EX-4 | No | 23.1 + 0.5 | adhesive | 2 + 0 | cohesive |
| | | (6.4 ± 0.1) | (clean) | | |
| CE-3 | Yes | 22.2 + 1.2 | adhesive | 3015 + 438 | cohesive |
| | | (6.2 ± 0.3) | (clean) | | |
| EX-3 | Yes | 19.2 + 0.5 | adhesive | 107 + 2 | cohesive |
| | | (5.3 ± 0.1) | (clean) | | |
| EX-4 | Yes | 22.1 + 1.3. | adhesive | 233 + 7 | adhesive |
| | | (6.1 ± 0.4) | (clean/ | | |
| | | | ghosting) | | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A pressure-sensitive adhesive composition comprising:
a copolymer comprising:
a first divalent monomer unit represented by the structure 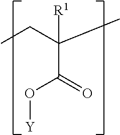
wherein
Y is a heterohydrocarbyl group having up to having up to 18 carbons; and
R¹ is —H or —CH₃; and
a second divalent monomer unit represented by the structure 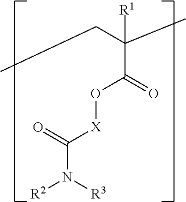
wherein
X is a hydrocarbylene group having up to 5 carbons;
R¹ is —H or —CH₃, and
each R² and R³ is independently —H or a hydrocarbyl group having up to 8 carbons.

2. The pressure-sensitive adhesive composition of claim 1, wherein X is an aliphatic hydrocarbylene group.

3. The pressure-sensitive adhesive composition of claim 1, wherein X is selected from the group consisting of —CH(CH₃)—, —CH(CH₃)CH₂CH₂—, —CH₂CH₂CH(CH₃)—, and combinations thereof.

4. The pressure-sensitive adhesive composition of claim 1, wherein the copolymer comprises 99.5 wt. % to 75 wt. %, of the first divalent monomer unit.

5. The pressure-sensitive adhesive composition of claim 1, wherein the copolymer comprises 0.5 wt. % to 25 wt. % of the second divalent monomer unit.

6. The pressure-sensitive adhesive composition of claim 1, wherein the first divalent monomer unit is selected from the group consisting of an isooctylacrylate divalent monomer unit, a 2-ethylhexylacrylate divalent monomer unit, a butylacrylate divalent monomer unit, and combinations thereof.

7. The pressure-sensitive adhesive composition of claim 1, wherein the copolymer is free of monomer units selected from the group consisting of acrylamide monomer units, N,N-dimethylacrylamide monomer units, and combinations thereof.

8. The pressure-sensitive adhesive composition of claim 1, further comprising a polar monomer.

9. The pressure-sensitive adhesive composition of claim 1, wherein the copolymer has an inherent viscosity of 0.35 to 2, optionally 0.75 to 1 as determined by the Inherent Viscosity Test.

10. The pressure-sensitive adhesive composition of claim 1, wherein the copolymer is crosslinked.

11. The pressure-sensitive adhesive composition of claim 1, further comprising an additive.

12. The pressure-sensitive adhesive composition of claim 11, wherein the additive is selected from the group consisting of a tackifier, a plasticizer, and combinations thereof.

13. The pressure-sensitive adhesive composition of claim 11, wherein the pressure-sensitive adhesive composition comprises from 3 parts to 60 parts by weight of the additive for every 100 parts by weight of the copolymer.

14. An article comprising a layer of the pressure-sensitive adhesive composition of claim 1 disposed on a substrate.

15. The article of claim 14, wherein the substrate comprises stainless steel.

16. The article of claim 15, wherein the pressure-sensitive adhesive compositions has a peel strength of at least 3 Newtons as determined by the Peel Adhesion Force Test.

17. A method of making a pressure-sensitive adhesive composition, the method comprising:
combining an initiator, an optional chain transfer agent, an optional solvent, and a copolymer comprising:
a first divalent monomer unit represented by the structure 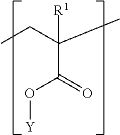
wherein
Y is a heterohydrocarbyl group having up to having up to 18 carbons; and
R¹ is —H or —CH₃; and
a second divalent monomer unit represented by the structure 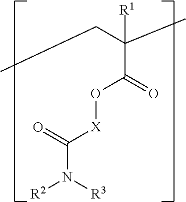
wherein
X is a hydrocarbylene group having up to 5 carbons;
R¹ is —H or —CH₃, and
each R² and R³ is independently —H or a hydrocarbyl group having up to 8 carbons to provide the pressure-sensitive adhesive composition.

18. The method of claim 17, wherein the initiator comprises a thermal initiator, a photoinitiator, and combinations thereof.

19. The method of claim 17, wherein the chain transfer agent comprises isopropanol.
